(19) United States
(12) Patent Application Publication
(10) Pub. No.: US 2026/0353541 A1
(43) Pub. Date: Nov. 5, 2026

(54) METHOD FOR CONTROLLING A LIGHT STAND SYSTEM, LIGHT STAND SYSTEM, AND COMPUTER PROGRAM PRODUCT

(71) Applicant: TILTA INC., Burbank, CA (US)

(72) Inventors: Yiling WANG, Shenzhen (CN); Wenping ZENG, Shenzhen (CN); Kefeng ZHOU, Shenzhen (CN)

(21) Appl. No.: 19/654,054

(22) Filed: Apr. 21, 2026

(30) Foreign Application Priority Data
Apr. 30, 2025 (CN) 202510571489.6

(51) Int. Cl. H05B 47/175; F21V 14/02; H05B 47/135; H05B 47/155; H05B 47/18; H05B 47/19

(52) U.S. Cl. CPC H05B 47/1985; F21V 14/02; H05B 47/135; H05B 47/155; H05B 47/184; H05B 47/19

(57) ABSTRACT

Disclosed herein is a method for controlling a light stand system. The system includes a light stand and a control terminal, with the control terminal capable of controlling the movement of the light stand. The control method includes receiving and sending control data, where the control data include a mark point, and each mark point corresponds to a specific movement position of the light stand. Based on the control data, the light stand is controlled to perform corresponding pitching and/or horizontal movements to reach the designated position.

### CROSS-REFERENCE TO RELATED APPLICATIONS

The present application for patent claims priority to and the benefit of pending Chinese Application No. 202510571489.6, filed Apr. 30, 2025, and hereby expressly incorporated by reference herein as if fully set forth below in its entirety and for all applicable purposes.

### TECHNICAL FIELD

The present disclosure pertains to the field of light stand control, specifically to a method for controlling a light stand system, the light stand system itself, and a computer program product for controlling the light stand system.

### INTRODUCTION

During the shooting process, lighting is a crucial factor influencing the outcome. To assist photographers in achieving desired photographic effects, auxiliary equipment such as light stands is commonly employed. A typical light stand has two arms with a light source mounted between them. However, existing light stands generally serve only a supporting function. When adjustments are needed, users often have to detach and reinstall the light at different angles, which is relatively inconvenient and limits the functionality of the light stand.

### SUMMARY

Some aspects of the present application provide a method for controlling a light stand system, the light stand system itself, and a computer program product that enable users to quickly adjust the light stand to preset positions without manual disassembly and installation, thereby enhancing the functionality of the light stand and effectively improving shooting efficiency.

Some aspects of the disclosure provide a method for controlling a light stand system, where the system includes a light stand and a control terminal configured to control the movement of the light stand, the control method including:

Receiving and sending control data, where the control data include a mark point, and each mark point corresponds to a specific movement position of the light stand; and

Controlling, based on the control data, the light stand to perform corresponding pitching and/or horizontal movements to reach the designated position.

A light stand system, including a handle and at least one light stand, where the handle and the light stand are communicatively connected via a NOW mode. The handle includes a control portion capable of receiving instructions to control the light stand to execute the method for controlling a light stand system as described above.

Through the configuration of mark points, when a user requires a specific shooting angle, a mark point for that angle can be set. When the shooting angle of the light stand needs adjustment, the user can send information about a specific mark point to the light stand via a remote control handle, enabling the light stand to respond quickly and adjust to the position corresponding to that mark point. Thus, users can quickly adjust the light stand to preset positions without manual disassembly and installation, enriching the functionality of the light stand and effectively improving shooting efficiency.

### BRIEF DESCRIPTION OF THE DRAWINGS

To elucidate the various aspects presented in the exemplary embodiments of the present application, the accompanying drawings for describing exemplary embodiments will be briefly introduced below. It is apparent that the accompanying drawings described herein represent merely exemplary embodiments of the present disclosure. A person of ordinary skill in the art could, without the necessity for inventive effort, develop additional drawings and variations based on the embodiments depicted in these drawings, without the need for further invention.

FIG. 1 is a schematic diagram illustrating a light stand system according to some aspects of the disclosure.

FIG. 2 is a flow chart illustrating a method for controlling a light stand system of according to some aspects of the disclosure.

FIG. 3 is a flow chart illustrating another method for controlling the light stand system according to some aspects of the disclosure.

FIG. 4 is a flow chart illustrating a control mode of the light stand system according to some aspects of the disclosure.

FIG. 5 is a drawing illustrating a computer program product.

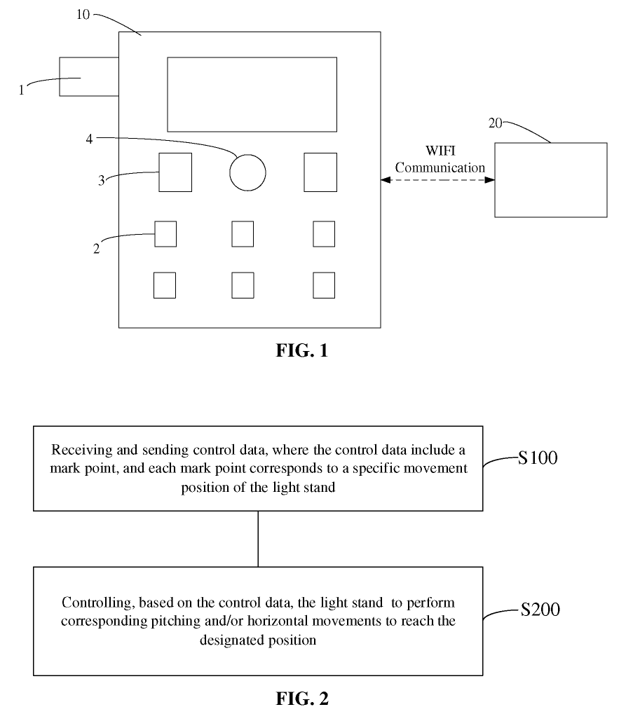

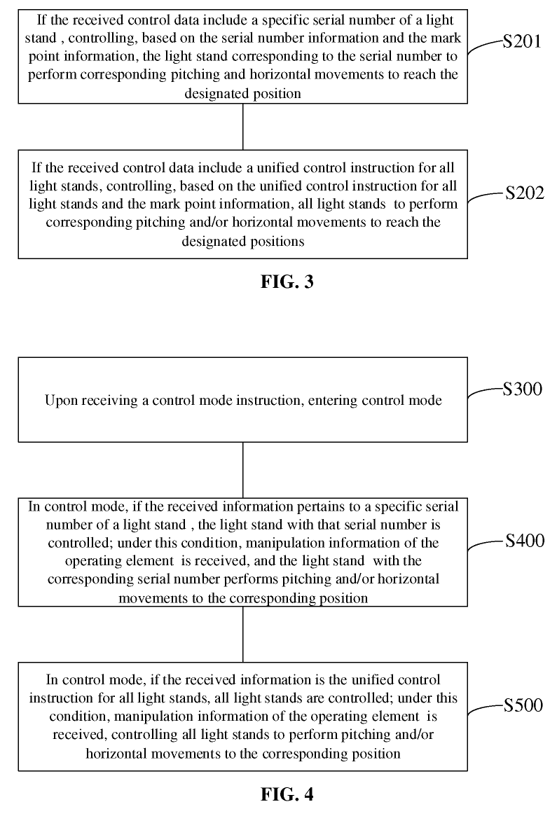

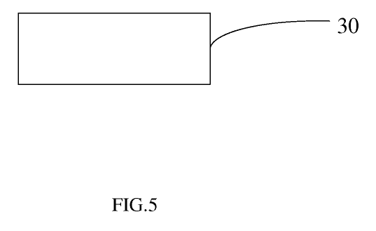

### LEGEND

10, handle; 20, light stand; 30, computer program product;
1, function key; 2, matrix keypad; 3, operating element; 4, encoder knob.

### DETAILED DESCRIPTION

The aspects, functional characteristics, and features of the disclosure will be further elucidated with reference to the embodiments and accompanying drawings.

Disclosed herein is a light stand 20, which may include one or more light stands. Users can control one or multiple light stands 20 via a control terminal (e.g., handle 10). Control communication modes include a NOW mode, 2.4G wireless communication, and a DMX (Digital Multiplex) mode for controlling the light stand 20. In some aspects, "NOW mode" refers to Wi-Fi Neighbor Awareness Networking (NAN), also known as Wi-Fi Aware, a low-power, short-range communication protocol enabling direct device discovery and communication without a traditional Wi-Fi network (e.g., router or hotspot). DMX (Digital Multiplex), e.g., DMX512, is a digital control protocol widely used in stage lighting, performance equipment, and architectural lighting. DMX controls multiple devices (e.g., luminaires) through serial communication, supporting up to 512 channels, with each channel corresponding to a device function (e.g., brightness, color, movement). 2.4G wireless communication refers to a wireless transmission technology operating in the 2.4GHz ISM (Industry Science Medicine) frequency band, ranging from 2.400GHz to 2.485GHz, a globally open and common wireless frequency band. It uses electromagnetic waves to propagate information in free space, modulating data onto a carrier wave in the 2.4GHz band for transmission, with the receiving end demodulating the data to achieve wireless communication between devices.

In some aspects, the handle 10 is equipped with a function key 1, which can be used to set a serial number for the light stand 20, adjust horizontal and/or pitching speeds (0-100%), and operate a return-to-center function, among others. Additionally, the pitching movement of the light stand 20 can be manually controlled via the function key 1. After powering on, the light stand 20 can automatically identify the control source (e.g., control terminal) based on a factory-preset priority order, for example, where the DMX control source has the highest priority, followed by the 2.4G mode control source, then the NOW mode control source, and manual control has the lowest priority. In some aspects, the light stand 20 includes a pitching axis control motor and a horizontal axis control motor, both employing closed-loop control using a single-turn absolute encoder on the output shaft. Consequently, after powering on, a control program can obtain the current pitching and horizontal positions, eliminating the need for a return-to-center process. The encoder allows knowing the position at each point (e.g., position) along the single turn of the output shaft, enabling the light stand 20 to obtain its position upon power-up, eliminating the need for a return-to-center process.

In some aspects, a method for controlling the light stand in the NOW mode, includes:

S100: Receiving and sending control data, where the control data include a mark point, and each mark point corresponds to a specific movement position of the light stand 20.

In some examples, one or more mark points may be preset. A mark point includes a preset position of the light stand 20. For example, the handle 10 may be equipped with a matrix keypad 2, where one key corresponds to one mark point, i.e., one movement position. When a user presses a certain key, the control portion of the handle 10 receives the user's control data and sends it to the light stand 20. The light stand 20 receives and parses the control data sent by the control portion of the handle 10 and executes the command, causing the pitching axis control motor and/or the horizontal axis control motor to respond and move to the corresponding position. It is understandable that users can record multiple mark points, which can be the same or different positions, depending on their recording.

S200: Controlling, based on the control data, the light stand 20 to perform corresponding pitching and/or horizontal movements to reach the designated position.

In some aspects, the control portion of the handle 10 controls the light stand 20 to perform corresponding pitching and/or horizontal movements to reach the designated position. The pitching movement can be achieved through the pitching axis control motor, and the horizontal movement can be achieved through the horizontal axis control motor. As mentioned above, both motors employ closed-loop control using a single-turn absolute encoder on the output shaft. Consequently, after powering on, a control program can obtain the current pitching and horizontal positions, eliminating the need for a return-to-center process. When the light stand 20 executes the command, it causes the pitching axis control motor and/or the horizontal axis control motor to move forward or backward according to the position corresponding to the mark point.

In some aspects, through the configuration of mark points, when a user requires a specific shooting angle, a mark point for that angle can be set. When the shooting angle of the light stand 20 needs adjustment, the user can send information about a specific mark point to the light stand 20 via the remote control handle 10, enabling the light stand 20 to respond quickly and adjust to the position corresponding to that mark point. Thus, users can quickly adjust the light stand 20 to preset positions without manual disassembly and installation, enhancing the functionality of the light stand 20 and effectively improving shooting efficiency.

Additionally, as mentioned above, users can configure the serial number for each light stand 20 using the function key 1, providing each light stand 20 with an identity identifier.

In some aspects, controlling, based on the control data, the light stand 20 to perform corresponding pitching and/or horizontal movements to reach the designated position includes:

S201: If the received control data include a specific serial number of a light stand 20, controlling, based on the serial number information and the mark point information, the light stand 20 corresponding to the serial number performs corresponding pitching and horizontal movements to reach the designated position.

In some aspects , the remote control handle 10 can be equipped with the same serial number. To control the light stand 20, the handle 10 may include a switching key, such as an encoder knob 4, used to switch the light stand 20 serial number. For example, after the handle 10 and the light stand 20 are communicatively connected via the NOW mode, the corresponding light stand 20 serial number is selected through the encoder knob 4, and the handle 10 is then configured to control the light stand 20 with that serial number. Further, the user can select any mark point via the matrix keypad 2, and the light stand 20 with that serial number can parse the position corresponding to that mark point and control the pitching axis control motor and/or the horizontal axis control motor to rotate to the corresponding position. In some examples, when the pitching position remains unchanged, the user can visually observe the change in horizontal movement; or when the horizontal position remains unchanged, the user can visually observe the change in pitching movement.

S202: If the received control data include a unified control instruction for all light stands, controlling, based on the unified control instruction for all light stands and the mark point information, all light stands 20 perform corresponding pitching and/or horizontal movements to reach the designated positions.

In some aspects, the remote control handle 10 may also be provided with a unified control instruction for all light stands. The user can operate the encoder knob 4 to switch to the unified control instruction for all light stands option, enabling the handle 10 to control all light stands 20 to rotate to the corresponding positions. Further, the user can select any mark point via the matrix keypad 2, and all light stands 20 can parse the position corresponding to that mark point and control the pitching axis control motors and/or the horizontal axis control motors to rotate to the corresponding positions.

As can be understood from the foregoing, each mark point described herein includes a corresponding position of the light stand 20, which can be accomplished through mark point setting. In some aspects, a process for using the mark point setting for a specific light stand 20 serial number, includes:

If an instruction for a mark point setting mode is received, the process enters the mark point setting mode.

In some aspects, this operation can also be performed using the function key 1 provided on the handle 10. Illustratively, it can also be accomplished by the encoder knob 4 mentioned above (including but not limited) or by a separate key, such as through electronic hardware like a joystick or a toggle switch. For example, double-clicking the function key 1 (including but not limited) enters a mode switch selection, allowing the user to select the mark point setting mode, enabling the handle 10 to enter the mark point setting mode. The user can then set each matrix keypad 2 to correspond to one mark point, as detailed below:

In the mark point setting mode, if received information is a specific serial number of a light stand 20, the process performs mark point setting on the light stand 20 corresponding to the serial number.

In some aspects, mark point setting can also be performed for a light stand 20 with a specific serial number, specifically achieved through the function key 1 provided on the handle 10. In some aspects, by rotating the encoder knob 4 to switch and select the corresponding light stand 20 serial number, the handle 10 is configured to perform mark point setting for the light stand 20 corresponding to that serial number.

When setting mark points on the light stand 20 corresponding to a specific serial number, corresponding mark point information is received, the light stand 20 with that serial number stores its current position information along with the corresponding mark point serial number, where the current position information corresponds to the respective mark point information.

In some aspects, a user selects a mark point serial number via the matrix keypad 2. The control portion of the handle 10 receives the corresponding mark point serial number signal, and the light stand 20 with the matching serial number receives this information, storing its current position and the corresponding mark point serial number. Alternatively, all light stands 20 on site can receive the information, with the light stand 20 having the matching serial number verifying its identity and storing the current position and corresponding mark point serial number, as the current position is exactly the location corresponding to the selected mark point. This setup allows users to record multiple mark point serial numbers for different light stands 20, enabling each light stand 20 to store positions corresponding to multiple mark point serial numbers. For instance, after selecting light stand 20 No. 2 and pressing the No. 2 key on the matrix keypad 2, the handle 10's control portion receives this operation information. Furthermore, the previously selected light stand 20 No. 2, undergoing mark setting, stores its current position information, which corresponds to the No. 2 key. This arrangement allows users to set mark points on all light stands 20 No. 2 on site and execute mark points on one or more of them afterward.

When the handle 10 is in mark point setting mode and the user needs to control the light stand 20 that underwent mark setting via this handle 10, they can switch to mark point execution mode as follows:

Upon receiving a mark point execution mode command, the light stand 20 can enter mark point execution mode.

In some aspects, this operation can be performed using the function key 1 on the handle 10, such as through the encoder knob 4 mentioned earlier (including but not limited) or a separate key, like double-clicking the function key 1 to transition the handle 10 into mark point execution mode. At this point, the user can proceed as needed as follows:

In mark point execution mode, if the received information pertains to a specific serial number of a light stand 20, mark point execution is performed on that light stand 20.

At this point, to control the target light stand 20 serial number, the user selects the corresponding light stand 20 number using the selector encoder. After selection, the handle 10 can adjust the position of the light stand 20 with that serial number. In some aspects, the corresponding light stand 20 can include one or more units. For example, when controlling light stand 20 No. 1, if there is only one unit, the handle 10 controls that single unit; if multiple units exist, the handle 10 controls all of them.

When executing mark points on the light stand 20 corresponding to the serial number, corresponding mark point information is received, enabling the light stand 20 to perform pitching and/or horizontal movements to the corresponding position based on this information.

In some aspects, the user can select the corresponding mark point serial number via the matrix keypad 2. In some aspects, selecting light stand 20 No. 1 and then the No. 2 key on the matrix keypad 2 causes all light stands 20 to receive the information. The corresponding light stand 20 No. 1 recognizes and parses this as a control command for itself, prompting its pitching axis control motor and/or horizontal axis control motor to move to the position corresponding to the No. 2 key. In some embodiments, among multiple light stands 20, light stand 20 No. 1 can receive and parse the information.

As described in this disclosure, control methods for a light stand 20 with a specific serial number have been introduced. Users can execute mark points on one or more light stands 20 via the handle 10, enabling rapid adjustment of corresponding light stands 20 to pre-recorded positions. This arrangement greatly facilitates user operations. In some aspects, during filming on set, which typically involves multiple light stands 20, lighting positions and angles can be tested and set beforehand by the filming staff. During actual shooting, if a light's angle is incorrect due to positional changes (including but not limited), the filming staff can quickly adjust the light stand 20 with the corresponding serial number via the handle 10. Alternatively, if several light stands 20 need adjustment, they can be set to the same serial number and controlled via the remote control handle 10, greatly facilitating the filming staff's work.

In some examples, at the beginning of a shoot on set, the filming staff can also adjust all light stands 20 to a preset condition and then make specific adjustments as needed. For adjusting all light stands 20, a light stand control method can include:

Upon receiving a mark point setting mode instruction, entering mark point setting mode.

In some aspects, as described above, this operation can be performed using the function key 1 on the handle 10, such as through the encoder knob 4 (including but not limited) or a separate key like double-clicking the function key 1 to transition the handle 10 into mark point setting mode. At this point, the user can set each matrix keypad 2 to correspond to one mark point, as detailed below:

In mark point setting mode, if the received information is a unified control instruction for all light stands, mark point setting is performed on all light stands 20.

Unlike the previous description, this setting applies to all light stands 20 and can be achieved specifically through the function key 1 on the handle 10. For example, the encoder knob 4 is used to select the unified control instruction for all light stands, prompting the handle 10 to perform mark point setting on all light stands 20.

When setting mark points on all light stands 20, corresponding mark point information is received, enabling all light stands 20 to store their current position information and the corresponding mark point serial number, where the current position information corresponds to the respective mark point information.

Considering that the control method described herein can manage multiple light stands 20, mark point setting can be performed for all of them. In some aspects, this can be done via the function key 1 on the handle 10, such as by selecting the unified control instruction for all light stands using the encoder knob 4 and then entering mark point recording setting for all light stands 20. The corresponding mark point serial number can be selected via the matrix keypad 2, and all light stands 20 store their current position and the corresponding mark point information. This arrangement provides users with a method to control all light stands 20, including a recording customization function to meet different needs for the staff, offering diversified and enriched functions. Filming staff can customize mark point position information or use other saved data. After setting mark points, users can control all light stands 20 via the remote control handle 10, specifically including:

Upon receiving a mark point execution mode command, entering mark point execution mode.

In some aspects, this operation can also be performed using the function key 1 on the handle 10, such as through the encoder knob 4 (including but not limited) or a separate key like double-clicking the function key 1 to transition the handle 10 into mark point setting mode as described earlier. At this point, the user can proceed as needed as follows:

In mark point execution mode, if the received information is the unified control instruction for all light stands, mark point execution is performed on all light stands 20.

At this time, the remote control handle 10 can control a light stand 20 with a specific serial number or all light stands 20. Therefore, the user can select the unified control instruction for all light stands via the selector encoder, prompting the handle 10 to switch to controlling all light stands 20. In this case, the handle 10 is configured to control all light stands 20.

With mark points on all light stands 20 set, corresponding mark point information is received, enabling all light stands 20 to perform pitching and/or horizontal movements to the corresponding position based on this information.

At this point, the user selects the corresponding mark point serial number via the matrix keypad 2, such as selecting No. 1 matrix keypad 2, and all light stands 20 move to the position corresponding to No. 1.

In some aspects, a method for controlling the movement of all light stands 20 is also provided. Combining this with the aforementioned method for controlling a specific light stand 20 and considering the working needs of the filming staff, a multi-point marking method is used to enable control over a specific light stand 20 or all light stands 20 for movement, effectively improving the working efficiency of the filming staff.

In some aspects, when the filming staff intends to adjust the movement position of a light stand 20 with a specific serial number or all light stands 20 in real time, a corresponding control mode is also provided, specifically including:

S300: Upon receiving a control mode instruction, entering control mode.

As described above, switching to control mode can also be performed via the function key 1. When needing to use this control mode, the user can operate the function key 1, such as by double-clicking it. The control portion of the remote control handle 10 receives the user's operation information and enters mode selection. After the user selects control mode, the handle 10 is configured to control the light stand 20 in this mode. Alternatively, electronic hardware such as a joystick or toggle switch can also be used for mode selection.

S400: In control mode, if the received information pertains to a specific serial number of a light stand 20, the light stand 20 with that serial number is controlled; under this condition, manipulation information of the operating element 3 is received, and the light stand 20 with the corresponding serial number performs pitching and/or horizontal movements to the corresponding position.

According to the foregoing, a light stand 20 with a specific serial number can be controlled, which can include one or more light stands 20 with the same serial number. It is also possible to control all light stands 20. Here, the control of a light stand 20 with a specific serial number is described first. The remote control handle 10 mentioned above can include, but is not limited to, an encoder knob 4 and a matrix keypad 2. The user can select the serial number of the controlled light stand 20 via the encoder or the matrix keypad 2. Furthermore, the remote control handle 10 can include an operating element 3, such as a scroll wheel or joystick. After the user makes the selection, the user operates the operating element 3, enabling the remote control handle 10 to receive the user's operation signal and send it to the light stand 20 on site. After parsing this information, the light stand 20 with the corresponding serial number recognizes that the serial number information matches its own and that the instruction is one that it needs to execute. Therefore, the light stands can perform closed-loop control over the pitching axis control motor and/or the horizontal axis control motor to move to the corresponding position. With this arrangement, if the filming staff finds that the lighting angle of a pre-marked position is not correct, they can switch to control mode and use the joystick to adjust the pitching and/or horizontal position of the light stand 20 in real time, making the control of the light stand 20 very flexible and convenient.

S500: In control mode, if the received information is the unified control instruction for all light stands, all light stands 20 are controlled; under this condition, manipulation information of the operating element 3 is received, controlling all light stands 20 to perform pitching and/or horizontal movements to the corresponding position.

Here, the user can select the unified control instruction for all light stands via the encoder. After selection, the user operates the operating element 3, enabling the remote control handle 10 to receive the user's operation signal and send it to all light stands 20. After parsing this information, all light stands 20 perform closed-loop control over their pitching axis control motors and/or horizontal axis control motors to move to the corresponding position.

On the other hand, considering the need to prioritize user demands, regarding control mode and mark point execution mode, in the latter, if the remote control handle 10 switches to remote control mode, mark point execution stops.

Also provided herein is a computer program product that stores a computer program. When executed by a processor, this computer program implements the method for controlling a light stand system described above.

All or part of the functions of the various methods in the above embodiments can be implemented by hardware or by computer programs. When implemented by computer programs, these programs can be stored in a computer-readable storage medium, which can include read-only memory, random access memory, magnetic disks, optical disks, hard disks, etc. The programs are executed by a computer to implement the above functions. In some aspects, the programs are stored in a memory of a device, and when executed by a processor, they implement all or part of the above functions. Additionally, when implemented by computer programs, these programs can also be stored in a storage medium such as a server, another computer, magnetic disk, optical disk, flash drive, or mobile hard disk, and saved to a memory of a local device by downloading or copying, or by updating the system of the local device with new versions. When executed by the processor, the programs in the memory implement all or part of the functions in the above embodiments.

What is claimed is:

1. A method for controlling a light stand system, wherein the light stand system comprises a light stand and a control terminal, and the control terminal is configured to control movement of the light stand, the method comprising:
receiving and sending control data, wherein the control data comprise a mark point, and the mark point corresponds to a movement position of the light stand; and
controlling, according to the control data, the light stand to perform corresponding at least one of a pitching movement or a horizontal movement to a position corresponding to the mark point.

2. The method for controlling a light stand system according to claim 1,
wherein the light stand comprises a plurality of light stands, and each light stand is provided with a corresponding serial number; and
wherein the control data further comprise a control instruction for a first light stand with a first serial number among the plurality of light stands, or a unified control instruction for the plurality of light stands, the method further comprising:
controlling, according to a serial number information and a mark point information, the first light stand corresponding to the first serial number to perform at least one of a pitching movement or a horizontal movement so as to move the first light stand to a corresponding position in response to the received control data comprising the first serial number of the first light stand; and
controlling, according to the unified control instruction for the plurality of light stands and the mark point information, the plurality of light stands to perform at least one of a pitching movement or a horizontal movement so as to move the plurality of light stands to a corresponding position if the received control data comprise the unified control instruction for the plurality of light stands.

3. The method for controlling a light stand system according to claim 2, wherein the method is applied to a control portion, the control portion is in communication with the plurality of light stands, and the control portion is configured with a mark point setting mode, further comprising:
entering the mark point setting mode in response to receiving an instruction of the mark point setting mode at the control portion;
in the mark point setting mode, performing mark point setting on the first light stand corresponding to the first serial number in response to receiving the first serial number of the first light stand; and
under the condition of performing the mark point setting mode on the first light stand corresponding to the first serial number, receiving corresponding mark point information, enabling the first light stand corresponding to the first serial number to store current position information and a corresponding mark point serial number, wherein the current position information corresponds to the corresponding mark point information.

4. The method for controlling a light stand system according to claim 3, wherein the control portion further comprises a mark point execution mode, the method further comprising:
entering the mark point execution mode in response to receiving a command of the mark point execution mode;
in the mark point execution mode, performing mark point execution on the first light stand corresponding to the first serial number in response to the received information being the first serial number of the first light stand; and
under the condition of performing mark point execution on the first light stand corresponding to the first serial number, receiving corresponding mark point information, enabling the first light stand corresponding to the first serial number to perform, according to the corresponding mark point information, at least one of a pitching movement or a horizontal movement to a corresponding position.

5. The method for controlling a light stand system according to claim 2, wherein the method is applied to a control portion, the control portion is in communication with the light stand, and the control portion is configured with a mark point setting mode, further comprising:
entering the mark point setting mode in response to receiving an instruction of the mark point setting mode;
in the mark point setting mode, performing mark point setting on the plurality of light stands in response to the received information being the unified control instruction for the plurality of light stands; and
under the condition of performing mark point setting on the plurality of light stands, receiving corresponding mark point information, enabling the plurality of light stands to store current position information and a corresponding mark point serial number, wherein the current position information corresponds to the corresponding mark point information.

6. The method for controlling a light stand system according to claim 5, wherein the control portion further comprises a mark point execution mode, comprising:
entering the mark point execution mode in response to receiving a command of the mark point execution mode;
in the mark point execution mode, performing mark point execution on the plurality of light stands in response to the received information being the unified control instruction for the plurality of light stands; and
under the condition of performing mark point execution on the plurality of light stands, receiving corresponding mark point information, enabling the plurality of light stands to perform, according to the corresponding mark point information, at least one of a pitching movement or a horizontal movement to a corresponding position.

7. The method for controlling a light stand system according to claim 6, wherein the control portion further comprises a control mode, the control terminal comprises an operating element, comprising:
entering the control mode in response to receiving an instruction of the control mode;
in the control mode, controlling the first light stand corresponding to the first serial number in response to the received information being the first serial number of the first light stand; and
under the condition of controlling the light stand corresponding to the first serial number, receiving manipulation information from the operating element, enabling the first light stand corresponding to the first serial number to perform at least one of a pitching movement or a horizontal movement to a corresponding position; and
in the control mode, controlling the plurality of light stands in response to the received information being the unified control instruction for the plurality of light stands; and
under the condition of controlling the plurality of light stands, receiving manipulation information from the operating element, enabling the plurality of light stands to perform at least one of a pitching movement or a horizontal movement to a corresponding position.

8. The method for controlling a light stand system according to claim 7, wherein the light stand further comprises a pitching motor and a horizontal motor, and the pitching motor and the horizontal motor each employ closed-loop control using a single-turn absolute encoder on an output shaft.

9. A light stand system, comprising a handle and at least one light stand, wherein the handle and the light stand are in communication connection via a wireless communication mode, the handle comprises a control portion, and the control portion is configured to receive instructions to control the at least one light stand to execute the method for controlling a light stand system according to claim 1.

10. A computer program product, comprising at least one of a computer program or instructions, wherein the at least one of computer program or instructions comprise the method for controlling a light stand system according to claim 1.
